(19) United States
(12) Patent Application Publication
(10) Pub. No.: US 2009/0157256 A1
(43) Pub. Date: Jun. 18, 2009

(54) PASSENGER DIFFERENTIATING APPARATUS WITH INDEPENDENT FRAME STRUCTURE

(75) Inventors: Jae Ho HWANG, Gyeonggi-do (KR); Byung Hyuk PARK, Gyeonggi-do (KR); Byeong Yeol KIM, Gyeonggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Gyeonggi-do (KR)

(21) Appl. No.: 12/057,411

(22) Filed: Mar. 28, 2008

(30) Foreign Application Priority Data
Dec. 17, 2007 (KR) 10-2007-0132762

(51) Int. Cl. G06F 17/00

(52) U.S. Cl. 701/36

(57) ABSTRACT

A passenger differentiating apparatus with an independent frame structure includes a passenger seat disposed to be movable in a back-and-forth direction within a car by a user, a pair of guide rails disposed below the passenger seat and configured to guide the movement of the passenger seat, a pair of load sensors disposed to be spaced apart from each other in a back-and-forth direction on one of the pair of guide rails to sense a load of a passenger sitting on the passenger seat, and an overload prevention unit disposed on the guide rails and configured to prevent damage to the pair of load sensors.

### BACKGROUND OF THE INVENTION

1. Field of the Invention

The present invention relates to an apparatus for determining whether to deploy an airbag cushion, which is an impact safety device, according to a passenger in an automobile in order to protect the passenger more safely in a vehicle crash, and its method.

2. Discussion of the Related Art

An airbag device is a device for protecting a passenger by absorbing a physical shock caused by a vehicle crash by using the elasticity of an airbag cushion. Such an airbag device may be classified into a driver seat airbag device, an assistant driver's seat airbag device, a side airbag device and so on.

By the way, an airbag cushion deployed by introducing gas into the airbag cushion is deployed at a high speed for the protection of passengers. Thus, if a passenger is an infant or a lightweight person, they may be instead injured by an impact caused by the deployment of the airbag cushion. Accordingly, whether to deploy the airbag cushion needs to be determined in consideration of the weight of a passenger. In consideration of this, the legislation of standards for restricting the deployment of an airbag cushion depending on the weight of a passenger weighed at a passenger seat under various conditions is in progress in North American regions.

Therefore, airbag device manufacturers must prepare means to satisfy these conditions for enhancement of the performance of airbag devices and for export to North American regions. For this, conventionally, four or more load sensors are installed on a passenger seat to weigh the passenger according to the seated state of the passenger, and the sum of the load values measured by the respective load sensors is compared with a reference value, to thus determine whether to deploy the airbag cushion.

However, an increase of the number of load sensors leads to the problem of increasing the cost of a passenger differentiating apparatus and decreasing price competitiveness. Thus, the efforts for solving this problem are in progress, but the results of research are insignificant due to technical difficulties.

Moreover, the load sensors are disposed in plural number on the bottom surface portion of the passenger seat in order to accurately detect the load of the passenger sitting on the passenger seat. An excessive load caused by the collision of a vehicle or inappropriate use of the passenger seat by the user is a primary reason that accurate sensors and systems should be provided.

### SUMMARY OF THE INVENTION

The present invention has been made in an effort to provide a passenger differentiating apparatus with an independent frame structure, which minimizes an error generated upon classifying passengers by optimizing the margin of classification by a load sensor, reduces the number of load sensors required for a passenger differentiating apparatus, and includes an overload prevention unit for preventing damage to the load sensors.

To achieve the foregoing object, there is provided a passenger differentiating apparatus with an independent frame structure in accordance with the present invention, which comprises: a passenger seat disposed to be movable in a back-and-forth direction within an automobile by a user; a pair of guide rails disposed below the passenger seat and for guiding the movement of the passenger seat; a pair of load sensors disposed to be spaced apart from each other in a back-and-forth direction on one of the pair of guide rails to sense the load of a passenger sitting on the passenger seat; and an overload prevention unit disposed on the guide rails and for preventing damage to the pair of load sensors.

Furthermore, each of the pair of guide rails comprises a lower channel disposed on the inside bottom of the automobile; and an upper channel disposed above the lower channel and having a slot hole for inserting one end of a frame constituting the framework of the passenger seat therein for movement, and the load sensors are disposed between the lower channel and the upper channel.

Furthermore, the overload prevention unit comprises: an anti-shock damper disposed between the load sensors and the lower channel and absorbing and dissipating a load transferred to the load sensors; and a stopper portion for restricting an excessive downward movement of the upper channel.

Furthermore, the anti-shock damper is made of rubber to absorbs tolerance generated in the assembling process.

Furthermore, part of the lower channel and part of the upper channel are disposed to be extended and overlapped with each other in an opposite direction, and the extended part of the lower channel being positioned at the outside, and the stopper portion is a bolt for fastening the part of the lower channel and the part of the upper channel that are disposed to be overlapped with each other by passing through from inside to outside.

Furthermore, a first through hole through which the bolt passes is formed at part of the lower channel, and a second through hole for fastening the bolt passing through the first through hole is formed at part of the upper channel, the first through hole having a larger diameter than the second diameter has.

Furthermore, the bolt is fastened to the second through hole such that, if no load is transferred from the passenger seat, the bolt is not interfered by the inner peripheral end of the first through hole, and if an excessive load is transferred from the passenger seat, the bolt is interfered with the inner peripheral end of the first through hole.

The passenger differentiating apparatus with an independent frame structure in accordance with the present invention can cut down production costs by reducing the number of load sensors as essential components required for passenger differentiation, prevent damage to the load sensors and cut down the replacement cost of the product incurred by the damage by further including an overload prevention unit, and simplify the production process of the passenger seat and the automobile by making the assembling process of the passenger differentiating apparatus independent.

Furthermore, the passenger differentiating apparatus with an independent frame structure in accordance with the present invention can prevent a safety accident to a passenger due to the wrong operation of the airbag device by keeping the load sensors from damage before the occurrence of a vehicle collision.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a plane view showing a passenger seat and an airbag device within an automobile in accordance with the present invention;

FIG. 2 is a partial cutaway view illustrating the passenger seat in accordance with the present invention;

FIG. 3 is a perspective view showing the installation place of a passenger differentiating apparatus with an independent frame structure in accordance with the present invention;

FIG. 4 is a perspective view showing a guide rail of the components of FIG. 3. FIG. 5 is a plane view showing the guide rail of FIG. 4 and its peripheral parts;

FIG. 6 is a cross sectional view taken along line A-A of FIG. 5 and a partial perspective view thereof;

FIG. 7 is a cutaway perspective view taken along line B-B of FIG. 5;

FIG. 8 is an exploded perspective view showing the guide rail of FIG. 4;

### DETAILED DESCRIPTION OF THE PREFERRED EMBODIMENTS

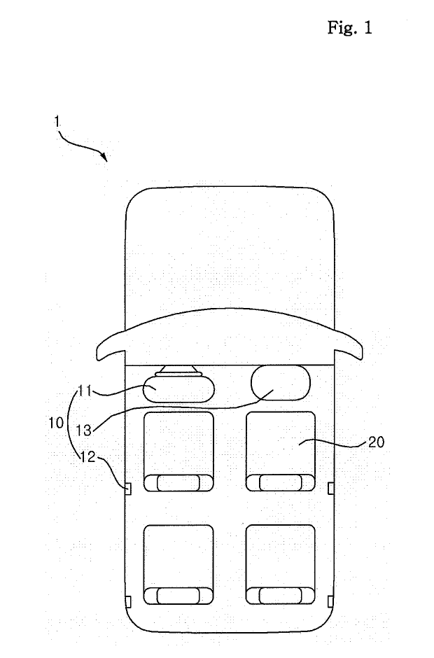

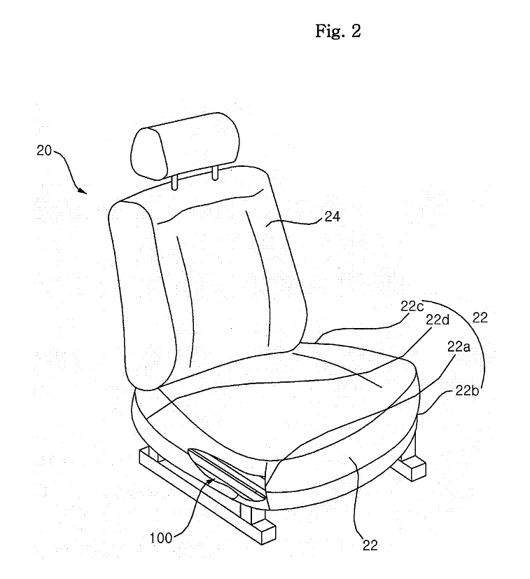

Hereinafter, a preferred embodiment of the present invention will be described with reference to FIGS. 1 to 10.

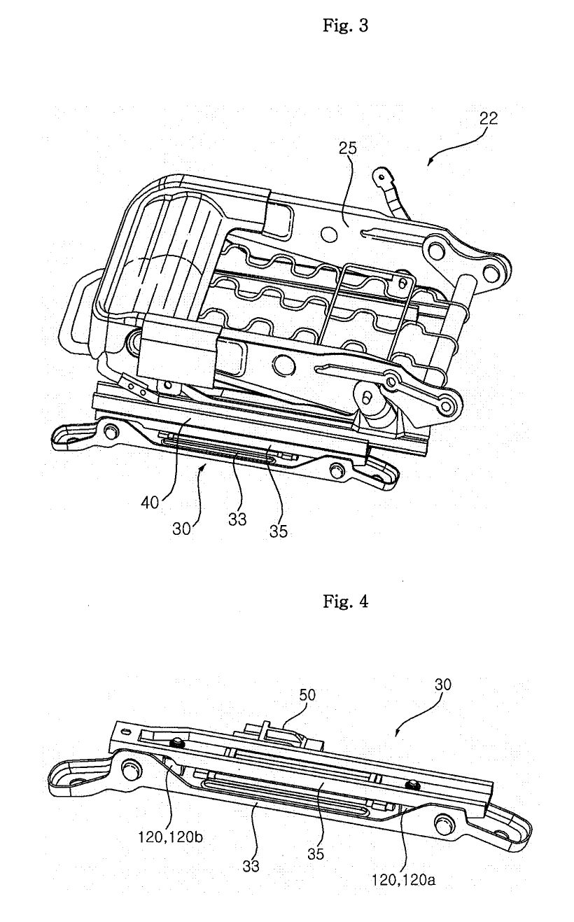

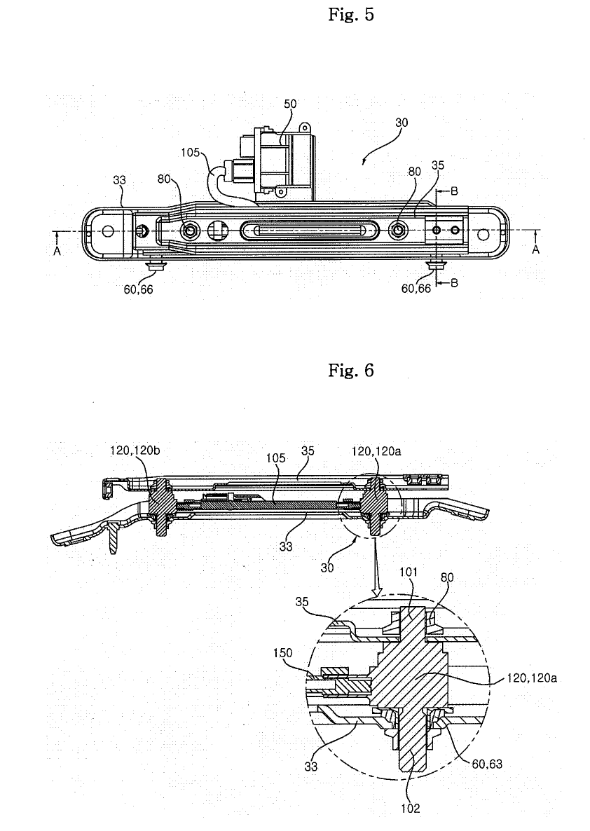

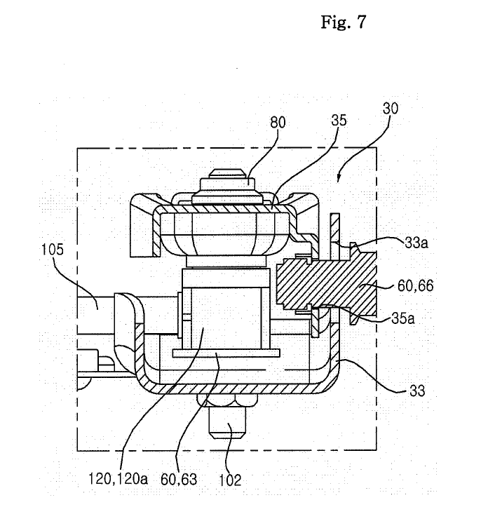

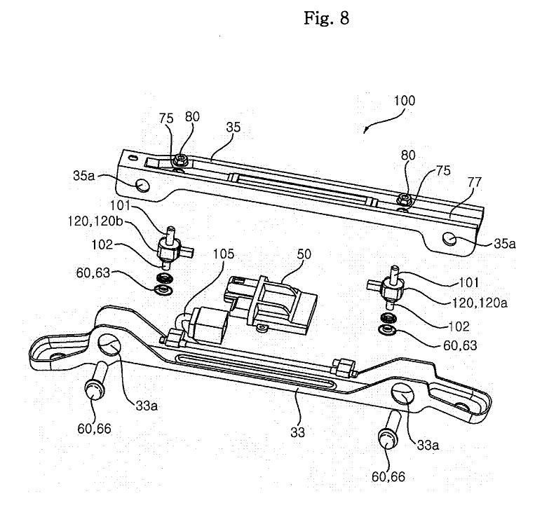

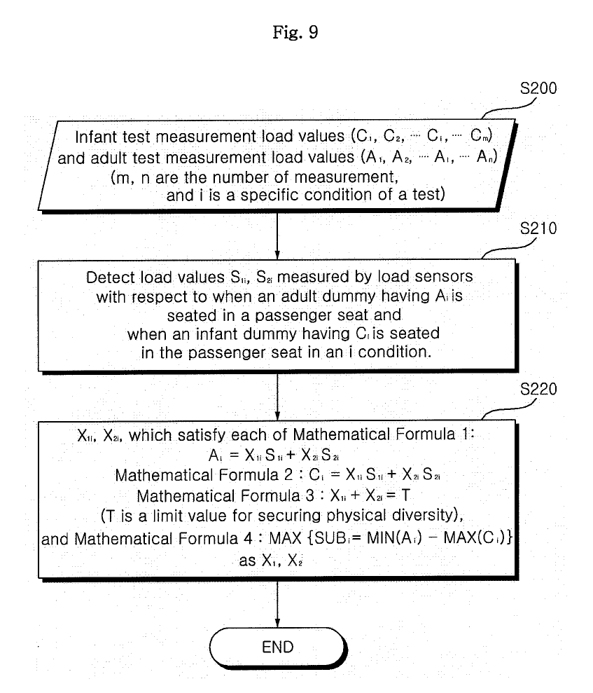

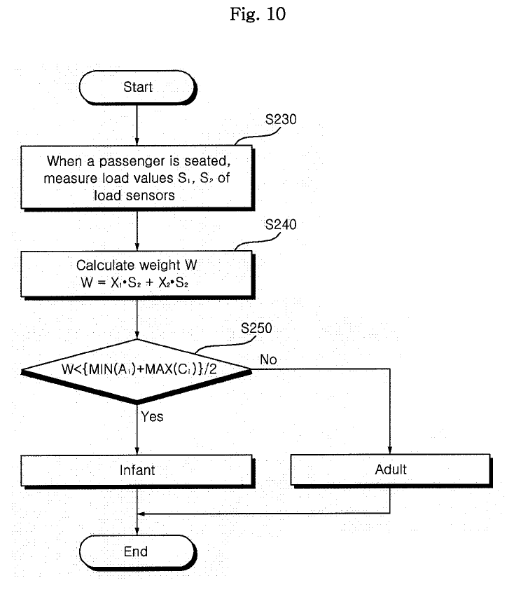

FIG. 1 is a plane view showing a passenger seat and an airbag device within an automobile in accordance with the present invention. FIG. 2 is a partial cutaway view illustrating the passenger seat in accordance with the present invention. FIG. 3 is a perspective view showing the installation place of a passenger differentiating apparatus with an independent frame structure in accordance with the present invention. FIG. 4 is a perspective view showing a guide rail of the components of FIG. 3. FIG. 5 is a plane view showing the guide rail of FIG. 4 and its peripheral parts. FIG. 6 is a cross sectional view taken along line A-A of FIG. 5 and a partial perspective view thereof. FIG. 7 is a cutaway perspective view taken along line B-B of FIG. 5. FIG. 8 is an exploded perspective view showing the guide rail of FIG. 4.

First, referring to FIG. 1, a car in accordance with the present invention will be described.

In order to protect the safety of a passenger from an impact force generated in a collision of the automobile, the automobile 1 comprises an airbag device 10 and a passenger seat 20 on which a passenger is seated. The airbag device 10 can be classified into a driver seat airbag device 11 for preventing a driver from being injured in a front collision of the automobile, a front airbag device having an assistant driver's seat airbag device 13 for preventing a person sitting on the assistant driver's seat from being injured by an impact from a front collision of the automobile, and a side airbag device 12 for preventing a passenger from being injured by an impact from a side collision of the automobile.

The airbag device 10 protects a passenger by deploying an airbag cushion by gas ejected by the explosion of a gas ejector provided therein in the event of a car crash, thus making continuous use difficult if the airbag cushion is deployed upon a car crash. Therefore, the airbag cushion must be deployed under necessary circumstances.

However, if the deployment of the airbag cushion is determined only on condition that a car crashes, for example, the airbag cushion is deployed even if no passenger is seated on the assistant driver's seat, and this may result in unnecessary additional costs. Accordingly, the deployment of the airbag cushion needs to be determined by identifying whether a passenger is seated or not.

Further, the airbag cushion included in the airbag device 10 is deployed at such a high speed as to reach approximately 250 km/h by the gas ejected from the gas ejector provided therein in the event of a car crash as described above. This is because the airbag cushion should be deployed faster than the passenger directly collides with a structure in the automobile by an inertial force generated by the collision of the automobile, so that the airbag cushion can perform its primary function.

However, since the deployment speed of the airbag cushion is quite high, the kinetic energy of the airbag cushion is relatively large, and thus if the energy caused by the deployment of the airbag cushion is transferred to the passenger, the passenger may be injured due to the airbag cushion.

Accordingly, it is not always preferable to deploy the airbag in a car crash, but the airbag should be deployed in consideration of the speed at which a passenger collides with an automobile structure in the event of a car crash and the deployment speed of the airbag cushion.

Such a condition can be satisfied by measuring the load of the passenger seated on a passenger seat 20. In other words, if the load of the passenger is less than a predetermined level, the speed at which the passenger bounces off is increased due to an impact caused by the deployment of the airbag cushion. This may cause more serious injury due to the impact caused by the deployment of the airbag cushion, and thus the load of the passenger should be the consideration criteria of the deployment of the airbag cushion.

Based upon this issue, there is a need to establish specific standards so as to suppress the deployment of the airbag cushion if the load of the passenger seated is less than a predetermined level. In some countries, i.e., in North American regions, these standards are specified by the regulation (FMVSS 208), under which cars not meeting these standards are prohibited from import. These standards are established by measuring minimum 30 test items by using an adult dummy and minimum 1,200 test items by using an infant dummy.

Consequently, in order to ensure the safety of a passenger and export airbag devices to North American regions, airbag devices should be designed so as to determine the deployment of an airbag cushion by measuring the load of a passenger seated on the passenger seat 20 under various conditions and comparing the measured load with the aforementioned reference value.

For this, an automobile has to be provided with means for determining the presence of a passenger seated on the passenger seat 20 and classifying the seated passenger is an infant or an adult.

Hereinafter, the passenger differentiating apparatus 100 with an independent frame structure in accordance with the present invention will be described with reference to FIGS. 2 and 3.

As shown in FIG. 2, the passenger seat 20 can be divided into a waist supporting portion 24 for supporting and backing the waist and back regions of a seated passenger and a bottom portion 22 for supporting the load of the passenger.

Although deviations exist according to the angle of the waist supporting portion 24 or the seated posture of the passenger, most of the weight of the passenger is supported by the bottom portion 22, and thus the passenger differentiating apparatus 100 for differentiating whether a passenger is seated and the type of the passenger is disposed in the bottom portion 22.

The passenger differentiating apparatus includes a plurality of load sensors 120 for measuring the weight of a passenger seated on a passenger seat 20.

Various types of weight detecting sensors may be employed as the load sensors 120. For instance, the load sensors 120 may be implemented by using various means within the level of those skilled in the art, including measuring the distortion of an elastic element distorted according to a pressure applied to the bottom portion 22 by the passenger or detecting and measuring a change in resistance according to pressure.

The load sensors 120 in the passenger differentiating apparatus with an independent frame structure in accordance with the present invention will be illustrated with respect to the case where a pair of load sensors 120 is disposed on the bottom portion 22 of the passenger seat 20.

More specifically, the bottom portion 22 of the passenger seat 20 includes a metal frame 25 constituting an inside framework and a cushion portion (not shown) made of a foam material connected to the frame 25 and covering the top of the frame 25.

In most of the cars being produced recently, the passenger seat 20 is disposed so as to be slidably movable in a back-and-forth direction on the inside bottom of the automobile 1 by a user so that passengers with different body sizes can be comfortably seated on the passengers seat 20 in the most comfortable posture

Here, a pair of guide rails 30 for guiding the back and forth movement of the passenger seat 20 disposed below the bottom portion 22 of the passenger seat 20. It is preferable that the pair of guide rails 30 is longitudinally disposed in a back-and-forth direction on the inside bottom of the automobile 1, being spaced apart a predetermined gap from each other in a left and right direction.

As described above, in the passenger differentiating apparatus with an independent frame structure in accordance with the present invention, although the load sensors 120 are disposed on the guide rails 30, the scope of the present invention should not be construed as restricted or limited by the installation place of the load sensors 120. In other words, depending on the type of a car, the passenger seat 20 may be disposed in such a manner as to be fixed to the inside bottom of the automobile 1 and not slidably moved in the back-and-forth direction. In this case, the guide rails 30 cannot be assumed as essential components. Thus, in the case where the load sensors 120 are disposed on a support structure supporting the bottom portion 22 of the passenger seat 20 from below, they are intended to be included in this invention regardless of the name by which they are called.

In a preferred embodiment of the present invention, for the convenience of description, the description will be made with the assumption that the passenger seat 20 is slidably moved in a back-and-forth direction by being guided by the guide rail 30. The picture in which the load sensors are disposed on the guide rails 30 will be described below. Here, for the convenience of description, any one 120a or 120b of the pair of the load sensors 120 will be described by way of example. It is assumed that the disposition state of the other load sensor 120a or 120b is the same as that of the load sensor 120a or 120b to be described below except for the installation position thereof.

Each of the guide rails 30 includes, as shown in FIGS. 4 to 8, a lower channel 33 fixed to the inside bottom of the automobile 1 and an upper channel 35 disposed above the lower channel 33. The load sensors 120 are disposed between the lower channel 33 and the upper channel 35. The load sensors 120 disposed between the lower channel 33 and the upper channel 35 have projecting ends 101 and 102 projected a predetermined distance upward and downward, respectively. The upper and lower projecting ends 101 and 102 are inserted into fastening holes 75 formed on the lower channel 33 and the upper channel 35 and projected downwardly of the lower channel 33 and upwardly of the upper channel 35, respectively, and fixed to respective mounting bolts 80 which are to be fastened to the upper and lower projecting ends 101 and 102 from outside.

A slot hole 77 may be longitudinally formed on the upper channel 35 in a back-and-forth direction so that a movable member 40 connected to a lower portion of the frame 25 may be inserted therein and slidably moved.

The load sensors 120 are disposed between the lower channel 33 and the upper channel 35, and when a passenger is seated on the passenger seat 20, the upper channel 35 applies a predetermined pressure while pressing the load sensors 120, whereupon the load sensors 120 measure the weight of the passenger.

However, if a load transferred to the load sensors 120 is excessive, there is a risk of damage to the load sensors 120. In the present invention, an overload prevention unit 60 disposed on the guide rails 30 is further included in order to prevent damage to the load sensors 120.

The overload prevention unit 60 includes an anti-shock damper disposed between the load sensors 120 and the lower channel 33 and absorbing and dissipating a load transferred to the load sensors 120 and a stopper portion 66 for restricting an excessive downward movement of the upper channel.

In the preferred embodiment of the present invention, as described above, the anti-shock damper 63 is disposed between the load sensors 120 and the lower channel 33.

As shown in FIG. 3, the anti-shock damper 63 serves to allow the load sensors 120 to measure the load being transferred when the load transferred from the passenger is transferred to the load sensors 120 through the upper channel 35 and then absorb and dissipate it when the load is transferred to the lower channel 33 disposed below the load sensors 120. In this manner, the anti-shock damper 63 prevents the overload sensors 120 from receiving an excessive load and being damaged by absorbing and dissipating the load transferred to the lower channel 33.

Furthermore, the anti-shock damper 63 performs the function of compensating for an assembly tolerance generated in the assembling and fastening of the load sensors 120, as well as the function of preventing damage to the load sensors 120. That is, in the case where a predetermined assembly tolerance is generated between the load sensors 120 to be assembled and the lower channel 33 and the upper channel 35, the assembly tolerance can be compensated for by disposing the anti-shock damper 63 having a size corresponding to the assembly tolerance between the load sensors 120 and the upper channel 35.

The anti-shock damper 63 may be formed in a ring shape which is fit to the upper and lower projecting ends 101 and 102 of the load sensors 120. Further, the anti-shock damper 63 is preferably made of rubber which can absorb the predetermined load transferred to the lower channel 33 from the load sensors 120.

The anti-shock damper 63 of this type is advantageous in that the existing construction can be used as it is without any particular change in shape because it is fit to the upper and lower projecting ends 101 and 102 of the load sensors 120 having the same shape as the existing ones.

The stopper portion 66 may be constructed of a bolt 66 for fastening through both of the lower channel 33 and the upper channel 35 in a horizontal direction from one side.

Therefore, it is preferable that one end of the lower channel 33 and one end of the upper channel 35 are extended in an opposite direction so as to be overlapped with each other such that the bolt 66 is fastened in the horizontal direction. However, one end of the lower channel 33 and one end of the upper channel that are overlapped with each other have to be spaced apart from each other. This is to prevent the load transferred to the load sensors 120 from the upper channel 35 from being distributed to the lower channel 33 by the lower channel 33 and the upper channel 35 being interfered with each other.

In the passenger differentiating apparatus with an independent frame structure in accordance with the preferred embodiment of the present invention, one end of the lower channel 33 is disposed to be positioned outside the upper channel 35.

A first through hole 33a and a second through hole 35a through which the bolt 66 passes from outside to inside are formed at one end of the lower channel 33 and one end of the upper channel 35, respectively. Here, the first through hole 33a formed on the lower channel 33 is preferably larger than the second through hole 35a formed on the upper channel 35 so that the bolt 66 can pass through. However, the second through hole 35a formed on the upper channel 35 preferably has a size corresponding to the outer peripheral size of the bolt 66 to such an extent as to fasten the bolt 66 and keep it from falling out.

This is because, if the bolt 66 fixed to the upper channel 35 is interfered with the inner peripheral end of the first through hole 33a formed at one end of the lower channel 33 and fixed so as to keep the upper channel 35 from moving in an up-and-down direction, the load transferred to the upper channel 35 is directly transferred and distributed to the lower channel 33 via the bolt 66, thus making it impossible to allow the load sensors 120 to accurately measure the weight of the passenger.

Therefore, if no load is transferred from the passenger seat 20 in normal times, the bolt 66 is fastened to the upper channel 35 so as to be kept from contacting with the first through hole 33a formed on the lower channel 33. Otherwise, if an excessive load is transferred to the passenger seat 20 when the passenger is seated, thus excessively moving the upper channel 35 downward, the bolt 66 prevents damage to the load sensors 120 by being interfered with the inner peripheral end of the first through hole 33a formed on the lower channel 33.

The stopper portion 66 of this type has the merit that, like the anti-shock damper 63, it can be easily provided without any change of a conventional layout design of parts because it can be mounted by changing only parts of the lower channel 33 and upper channel 35 in shape.

As shown in FIG. 5 and its subsequent drawings, the load sensors 120 may be connected by a wire harness 105 for conducting the load sensors 120 and a control unit 50 disposed between the pair of guide rails 30.

The passenger differentiating apparatus having an independent frame structure in accordance with the present invention suggests that a pair of load sensors 120 should be disposed only on the guide rail 30 disposed at one side among the pair of guide rails 30. That is to say, conventionally, a relatively large number of load sensors 120 are disposed in order to measure the weight of a passenger seated on the passenger seat more accurately, but an increase of the number of load sensors 120 necessarily leads to the problem of an increase of costs.

Therefore, the passenger differentiating apparatus having an independent frame structure in accordance with the present invention chooses to eliminate as many the number of load sensors 120 as possible as far as the passenger seated on the passenger seat 20 can be differentiated.

The passenger differentiating apparatus having an independent frame structure in accordance with the present invention has the advantage of reducing the number of load sensors 120 to be disposed at the other side and accordingly cutting down the costs of the wire harness 105 because only a pair of load sensors 120 are disposed on the guide rail 30 disposed at one side among the pair of guide rails 30 as described above, and the advantage of simplifying the design of the lower portion of the passenger seat 20 because there is no need to extend the wire hardness 105 toward the guide rail 30 disposed at the other side.

Furthermore, the passenger differentiating apparatus having an independent frame structure in accordance with the present invention can enhance the performance of the product by including an overload prevention unit 60 for preventing damage to the load sensors 120 even if an excessive load is transferred from the passenger seat 20.

Meanwhile, as described above, in order to measure the weight of the passenger seated on the passenger seat 20, it is naturally preferable that a larger number of load sensors 120 should be disposed on the pair of guide rails 30. This is because an increase of the number of load sensors 120 is directly linked to the accuracy of the measurement in general.

If the load sensors 120 are installed on both of the pair of guide rails 30 corresponding to corner regions 22a, 22b, 22c, and 22d of the bottom portion 22 of the passenger seat 20, the load sensors 120 can detect the weight value of the passenger by measuring load values applied by the passenger and adding the load values.

When various conditions, such as whether the passenger is wearing a safety belt, the seated posture of the passenger, etc., change, the load applied to the bottom portion by the passenger changes too, thereby changing the weight value thereof, but the change is within a predetermined range. And, the weight value measured in this manner is compared with a reference value specified in the US Regulation, and if the weight value exceeds the reference value, the passenger is identified to be an adult, and if the weight value is less than the reference value, the passenger is identified to be an infant or it is identified there is no passenger seated.

In this state, in the event of collision of the automobile 1 during driving, if it is judged that the passenger is an adult, the airbag cushion is deployed to thus prevent the passenger from colliding with an interior structure of the automobile 1.

On the other hand, if the seated passenger is identified to be an infant, the airbag cushion is not deployed to thus prevent injury caused by collision caused by the deployment of the airbag cushion.

By the way, the classification of passengers accompanies a certain error. Still, the classification of passengers is the most significant function of the passenger differentiating apparatus, and thus it is preferred to adjust the margin of classification to a sufficiently large level so that the classification of passengers can be done properly around the reference value. However, the standards of the US regulation are very strict, so their classification margin should be considerably large. In order to maintain an appropriate margin of classification, a plurality of load sensors 120 have to be disposed at proper positions in the passenger differentiating apparatus.

In other words, as described above, in case of the bottom portion 20 of such a shape having four corner regions disposed therein, it is preferred to dispose the load sensors 120 on both of the guide rails 30 corresponding to the respective corner regions 22a, 22b, 22c, and 22d of the passenger seat 20.

Under this circumstance, however, if at least one of the load sensors 120 is substituted for a dummy sensor or eliminated, it is difficult to maintain an appropriate margin of classification in various conditions that change by external variables, such as various seated states of a passenger.

Accordingly, when using a passenger differentiating apparatus for sensing a load by a general method, it is impossible to reduce the number of load sensors 120 and substitute parts of them for dummy sensors, or especially, the standards of the US regulation cannot be satisfied.

However, in the present invention, the number of load sensors 120 can be eliminated drastically by the concept of weighted load values to be derived as follows.

That is to say, if a passenger is seated on the passenger seat 20, it is not possible to substitute parts of the load sensors 120 for dummy sensors and thus reduce the number of load sensors 120. This is because if the number of load sensors 120 is reduced, the margin of classification of a seated passenger with respect to weight decreases, thereby deteriorating the performance of classification of passengers.

Accordingly, if it is desired to reduce the number of load sensors 120, a sufficient classification margin should be ensured so that a passenger can be classified by the reduced number of load sensors 120.

For this, in the sensing of loads by the respective first and second load sensors 120a and 120b, it is preferred to select respective weighted load values X1 and X2 so that the classification margin can be the highest, thus optimizing the capability of identification for classifying passengers into infants and adults.

Based upon this theoretical basis, the sum of values, which are obtained by multiplying respective load values S1 and S2, measured by the first and second load sensors 120a and 120b provided in the passenger differentiating apparatus when the passengers is seated on the passenger seat 20, by the aforementioned weighted load values X1 and X2, are selected as the weight value W of the passenger, and this weight value is compared with the aforementioned reference value to classify the passenger, resultantly optimizing the classification margin. By employing this passenger differentiation method, the number of load sensors 120 can be reduced.

Hereinafter, the process of determining the weighted load values will be described with reference to FIG. 9.

As described above, in the step S200, infant test measurement weight values {C}_{1} measured when an infant dummy (a dummy refers to a replica of a human being which is seated in a car in a crash test) is seated on the passenger seat 20 are collected under a specific predetermined condition of a plurality of conditions specified in the US regulation (FMVSS 208), and adult test measurement weight values {A}_{1} measured when an adult dummy is seated on the passenger seat 20 are collected under the same condition as the above predetermined condition.

The adult test measurement weight values {A}_{1} may be in plural as they are repetitively measured several times under the above predetermined condition, and the adult test measurement weight values {C}_{1} may be likewise in plural.

These test measurement weight values {A}_{1} and {C}_{1} may be the values measured in advance by the load sensors 120 prior to the reduction of the number of load sensors 120. The above predetermined condition may represent one of seated states of a passenger specified in the US regulation (e.g., the passenger is seated with their legs crossed or is wearing the safety belt).

Thereafter, in the step 210, under the predetermined condition, the adult dummy is seated on the passenger seat 20 provided with the passenger differentiating apparatus 100 of the present invention to measure load values {S}_{1i} and {S}_{2i} of each 120a and 120b of the load sensors 120, and the infant dummy is seated on the passenger seat 20 provided with the passenger differentiating apparatus 100 of the present invention to measure load values{S}_{1i} and {S}_{2i} of each 120a and 120b of the load sensors 120.

Thereafter, the step S220 of determining weighted load values is performed. The determination of weighted load values may be performed as follows. Firstly, a lowest adult test measurement weight value and a highest infant test measurement weight value are found, the lowest adult test measurement weight value being the lowest of adult test measurement weight values measured when the adult dummy is seated on the passenger seat 20 under the predetermined condition, and the highest infant test measurement weight value being the highest of infant test measurement weight values measured when the infant dummy is seated on the passenger seat 20 under the predetermined condition.

Afterwards, under the respective predetermined conditions, differences SUBi between the lowest adult test measurement weight value and the highest infant test measurement weight value are obtained. Also, the weighted load values are determined, under a first condition that the differences have the largest value, such that both of second and third conditions are satisfied, the second condition that the sum of values obtained by multiplying respective load values, which are measured by the plurality of load sensors 120 when the adult dummy is seated on the passenger seat 20, by the respective weighted load values, and the adult test measurement weight values are equal to each other, and the third condition that the sum of values obtained by multiplying respective load values, which are measured by the plurality of load sensors 120 when the infant dummy is seated on the passenger seat 20, by the respective weighted load values, and the infant test measurement weight values are equal to each other.

At this time, even if the number of load sensors 120 is reduced, the load sensors 120 of the present invention have to maintain physical equality with the load sensors prior to the reduction of the number of load sensors. Thus, the respective weighted load values may be determined so as to satisfy a fourth condition that the sum of the respective weighted load values is equal to a specific value. At this time, the specific value may be set to four if the previous number of load sensors 120 is four. However, it is apparent that the specific value is not necessarily limited to four or the number of load sensors.

Meanwhile, as illustrated in the embodiment of the present invention, if the number of load sensors 120 is three, weighted load values {X}_{1} and {X}_{2} may be determined under the following condition. Firstly, the condition of a test satisfying the following [Equation 4] is found. Then, under the condition that [Equation 4] is satisfied, the weighted load values {X}_{1i} and {X}_{2i} satisfying all of [Equation 1], [Equation 2], and [Equation 3] are selected, and {X}_{1i} and {X}_{2i} are determined as the weighted load values {X}_{1} and {X}_{2}.

{A}_{—}{i}={X}_{—}{1i}*{S}_{—}{1i}+{X}_{—}{2i}*{S}_{—}{2i} [Equation 1]

wherein {A}_{i} is an adult test measurement weight value measured in advance under a predetermined condition (i), {X}_{ki} is a weighted load value of a k-th weight load sensor under the predetermined condition (i), and {S}_{ki} is a load value measured by the k-the load sensor when the adult dummy is seated on the passenger seat,

{C}_{—}{i}={X}_{—}{1i}*{S}_{—}{1i}+{X}{2i}*{S}_{—}{2i} [Equation 2]

wherein {C}_{i} is an infant test measurement weight value measured in advance under the predetermined condition (i), {X}_{ki} is a weighted load value of a k-th weight load sensor under the predetermined condition (i), and {S}_{ki} is a load value measured by the k-the load sensor when the infant dummy is seated on the passenger seat,

{X}_{—}{1i}+{X}_{—}{2i}=T [Equation 3]

wherein {X}_{ki} is a weighted load value of a k-th weight load sensor under the predetermined condition (i), and T is a specific limit value,

MAX[MIN({A}_{i})−MAX({C}_{i})] [Equation 4]

wherein {A}_{i} is an adult test measurement weight value measured in advance under a predetermined condition (I), and {C}_{i} is an infant test measurement weight value measured in advance under the predetermined condition (i).

By applying the weighted load values determined in such a manner, the classification margin of the load sensors 120 is optimized, thereby resultantly reducing the number of load sensors 120.

Hereinafter, a method for differentiation of passengers by the passenger differentiating apparatus 100 of the present invention will be described with reference to FIG. 10.

Firstly, in the step S230, when a passenger is seated on the passenger seat 20, the respective load sensors 120a and 120b measure weighted load values {S}_{1} and {S}_{2}.

Next, the weight W of the passenger is calculated using the weighted load values {S}_{1}, {S}_{2}. Herein, the weight W can be derived by the following [Equation 5].

W={X}_{—}{1}*{S}_{—}{1}+{X}_{—}{2}{S}_{—}{2} [Equation 5]

Next, in the step S250, the weight W is compared with a reference value to classify whether the weight is large or not. The reference value is preferably the average value of the lowest value of the adult test measurement weight values {A}_{i} and the highest value of the infant test measurement weight values {C}_{i}. By setting the reference value as above, it is possible to optimize the classification margin of the weight W of a passenger detected by the load sensors 120 in the classification area of adult and infant. However, the present invention is not limited to the reference value set as above.

As described above, the present invention has been described with reference to the embodiment shown in the drawings, but it is just for illustration only and those skilled in the art will understand that there are various modifications and equivalent other embodiments therefrom. Accordingly, the sincere technical scope of the invention should be defined based on the technical spirit of the appended claims.

1. A passenger differentiating apparatus with an independent frame structure, comprising:
a passenger seat disposed to be movable in a back-and-forth direction within a car by a user;
a pair of guide rails disposed below the passenger seat and configured to guide the movement of the passenger seat;
a pair of load sensors disposed to be spaced apart from each other in a back-and-forth direction on one of the pair of guide rails to sense a load of a passenger sitting on the passenger seat; and
an overload prevention unit disposed on the guide rails and configured to prevent damage to the pair of load sensors.

2. The passenger differentiating apparatus of claim 1, wherein each of the pair of guide rails comprises a lower channel disposed on the inside bottom of the car; and an upper channel disposed above the lower channel and having a slot hole for inserting one end of a frame constituting the framework of the passenger seat therein for movement, and
the load sensors are disposed between the lower channel and the upper channel.

3. The passenger differentiating apparatus of claim 2, wherein the overload prevention unit comprises:
an anti-shock damper disposed between the load sensors and the lower channel and absorbing and dissipating a load transferred to the load sensors; and
a stopper portion that restricts an excessive downward movement of the upper channel.

4. The passenger differentiating apparatus of claim 3, wherein the anti-shock damper is made of rubber to absorb tolerance generated in an assembling process thereof.

5. The passenger differentiating apparatus of claim 3, wherein a portion of the lower channel and a portion of the upper channel are disposed to be extended and overlapped with each other in an opposite direction, and the extended portion of the lower channel being positioned at an outer side, and
the stopper portion is a bolt that fastens the portion of the lower channel and the portion of the upper channel that are disposed to be overlapped with each other by passing through from inside to outside.

6. The passenger differentiating apparatus of claim 5, wherein a first through hole through which the bolt passes is formed in the lower channel, and a second through hole that fastens the bolt passing through the first through hole is formed in the upper channel, the first through hole having a larger diameter than the second through hole.

7. The passenger differentiating apparatus of claim 6, wherein the bolt is fastened to the second through hole such that, if no load is transferred from the passenger seat, the bolt is not interfered with an inner peripheral end of the first through hole, and if an excessive load is transferred from the passenger seat, the bolt is interfered with the inner peripheral end of the first through hole.
